(19) United States
(12) Patent Application Publication
(10) Pub. No.: US 2026/0152225 A1
(43) Pub. Date: Jun. 4, 2026

(54) STEERING APPARATUS AND METHOD OF CONTROLLING THE SAME

(71) Applicant: HL MANDO CORPORATION, Pyeongtaek-si (KR)

(72) Inventor: Jinhwan KIM, Pyeongtaek-si (KR)

(73) Assignee: HL MANDO CORPORATION, Pyeongtaek-si (KR)

(21) Appl. No.: 19/226,718

(22) Filed: Jun. 3, 2025

(30) Foreign Application Priority Data
Nov. 29, 2024 (KR) 10-2024-0174742

(51) Int. Cl. B62D 5/04; B62D 5/00

(52) U.S. Cl. CPC B62D 5/049; B62D 5/006

(57) ABSTRACT

A steering apparatus includes a steering wheel provided in a vehicle, a steering sensor configured to output first and second detection signals corresponding to a rotational displacement of the steering wheel, and a controller configured to identify occurrence of an error in the steering sensor caused by an external magnetic field based on the first and second detection signals, in which the controller identifies the occurrence of the error by comparing a change amount of at least one of the first and second detection signals within a reference time with a reference change amount in response to vehicle start-on and comparing a change rate of at least one of the first and second detection signals within the reference time with a reference change rate of at least one of the first and second detection signals within the reference time.

### CROSS-REFERENCE TO RELATED APPLICATIONS

This application claims the priority of Korean Patent Application No. 10-2024-0174742 filed on Nov. 29, 2024, in the Korean Intellectual Property Office, the disclosure of which is incorporated herein by reference.

### BACKGROUND

### Field

The disclosed disclosure relates to a steering apparatus and a method controlling the same.

### Description of the Related Art

A steering apparatus detects steering torque generated by a rotation of a steering wheel and controls a motor to supply steering assistance torque proportional to the detected steering torque, such that steering control of a vehicle may be performed.

The steering apparatus in the related art is configured such that the steering torque generated by the rotation of the steering wheel is transmitted to a rack bar through a rack-pinion mechanical part, and the steering assistance torque, which is generated by the motor in accordance with the steering torque generated by the rotation of the steering wheel is transmitted to the rack bar. In other words, the steering torque generated by the steering wheel and the steering assistance power generated by the motor are combined to move the rack bar in an axial direction.

Recently, there has been developed a steering-by-wire (SBW) type steering apparatus that allows the rack bar to move in the axial direction only by using the torque of the motor without mechanically connecting the steering wheel and the rack bar.

The steering apparatus adopts a sensor configured to measure a steering force applied by a driver. However, a magnet sensing-type sensor is sensitive to the influence of external magnetic fields, which may cause an erroneous operation of the steering apparatus.

### SUMMARY

An object achieved by the disclosed disclosure is to provide a steering apparatus capable of preventing an erroneous operation of a steering sensor caused by an introduction of an external magnetic field, and a method of controlling the same.

One aspect of the disclosed disclosure provides a steering apparatus including: a steering wheel provided in a vehicle; a steering sensor configured to output first and second detection signals corresponding to a rotational displacement of the steering wheel; and a controller configured to identify the occurrence of an error in the steering sensor caused by an external magnetic field based on the first and second detection signals, in which the controller identifies the occurrence of the error in the steering sensor by comparing a change amount of at least one of the first and second detection signals within a reference time with a reference change amount of at least one of the first and second detection signals within the reference time in response to start-on of the vehicle and comparing a change rate of at least one of the first and second detection signals within the reference time with a reference change rate of at least one of the first and second detection signals within the reference time.

The steering apparatus may further include: a steering column configured to support the steering wheel and rotate while corresponding to a rotation of the steering wheel; a rack bar assembly connected to a rotary shaft of a wheel provided in the vehicle; a steering motor connected to the rack bar assembly and configured to provide torque related to a movement of the rack bar assembly based on a steering control signal of the controller; and a steering driver configured to control a drive current supplied to the steering motor based on the steering control signal, and the controller may correct the steering control signal based on a torque value of the steering motor monitored at a predesignated reference time point and output the corrected steering control signal to the steering driver when the occurrence of the error in the steering sensor is identified.

The controller may be configured to detect the monitored torque value of the steering motor, identify effectiveness of the detected torque value by comparing a time point of storage of the detected torque value with a reference time point, and correct the steering control signal based on the torque value with the identified effectiveness.

The reference time point may be set to be before the time when the occurrence of the error in the steering sensor identified.

The controller may be configured to output the steering control signal to the steering driver for a predesignated reference output time.

The reference output time may be set to a time for which the steering sensor returns to a normal state after the external magnetic field is removed.

The steering sensor may include: a first sensor configured to detect a rotation of the steering column and measure torque applied to the steering column by a driver; and a second sensor configured to detect a rotation of the steering wheel made by the driver and measure a rotation angle of the steering column.

The first detection signal may include a measurement value of the torque applied to the steering column, and the second detection signal may include a measurement value of the rotation angle of the steering column.

The controller may be configured to output the steering control signal to the steering driver to linearly move the rack bar assembly based on at least one of the first and second detection signals.

The controller may be configured to output a warning notification by using an output device provided in the vehicle when the occurrence of the error in the steering sensor is identified.

Another aspect of the disclosed disclosure provides a method of controlling a steering apparatus, which includes a steering wheel provided in a vehicle, a steering sensor configured to output first and second detection signals corresponding to a rotation of the steering wheel, and a controller configured to identify the occurrence of an error in the steering sensor caused by an external magnetic field based on the first and second detection signals, the method including: identifying the occurrence of the error in the steering sensor by comparing a change amount of at least one of the first and second detection signals within a reference time with a reference change amount of at least one of the first and second detection signals within the reference time in response to start-on of the vehicle and comparing a change rate of at least one of the first and second detection signals within the reference time with a reference change rate of at least one of the first and second detection signals.

The method may further include: correcting, by the controller, a steering control signal based on a torque value of a steering motor monitored at a predesignated reference time point and outputting the corrected steering control signal to a steering driver when the occurrence of the error in the steering sensor is identified.

The method may further include: detecting, by the controller, the monitored torque value of the steering motor, identifying effectiveness of the detected torque value by comparing a time point of storage of the detected torque value with a reference time point, and correcting the steering control signal based on the torque value with the identified effectiveness.

The method may further include: setting, by the controller, the reference time point to a time point before the occurrence of the error in the steering sensor is identified.

The method may further include: outputting, by the controller, the steering control signal to the steering motor for a predesignated reference output time.

The method may further include: setting, by the controller, the reference output time to a time for which the steering sensor returns to a normal state after the external magnetic field is removed.

The steering sensor may include: a first sensor configured to detect a rotation of a steering column and measure torque applied to the steering column by a driver; and a second sensor configured to detect a rotation of the steering wheel made by the driver and measure a rotation angle of the steering column.

The first detection signal may include a measurement value of the torque applied to the steering column, and the second detection signal may include a measurement value of the rotation angle of the steering column.

The method may further include: outputting, by the controller, the steering control signal to the steering driver to linearly move the rack bar assembly based on at least one of the first and second detection signals.

The method may further include: outputting, by the controller, a warning notification by using an output device provided in the vehicle when the occurrence of the error in the steering sensor is identified.

According to one aspect of the disclosed disclosure, it is possible to provide the steering apparatus capable of identifying the occurrence of an error in the steering sensor caused by the introduction of the external magnetic field, and the method of controlling the same. Therefore, it is possible to prevent an erroneous operation of the steering motor by transmitting the corrected control signal to the steering driver.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating one example of a steering apparatus according to an embodiment of the disclosed disclosure;

FIG. 2 is a view illustrating one example of a control configuration of the steering apparatus according to the embodiment of the disclosed disclosure;

FIG. 3 is a view illustrating a torque sensor of the steering apparatus according to the embodiment of the disclosed disclosure;

FIG. 4 is a view illustrating a front surface of a magnet in FIG. 3;

FIG. 5 is a view illustrating a front surface of a stator in FIG. 3;

FIG. 6 is a view illustrating one example of a test signal for allowing the steering apparatus according to the embodiment of the disclosed disclosure to identify the occurrence of an error in a steering sensor;

FIG. 7 is a view illustrating one example of a network connection configuration of the steering apparatus according to the embodiment of the disclosed disclosure;

FIG. 8 is a view illustrating another example of the steering apparatus according to the embodiment of the disclosed disclosure;

FIG. 9 is a view illustrating another example of a control configuration of the steering apparatus according to the embodiment of the disclosed disclosure;

FIG. 10 is a view illustrating one example of a method of controlling the steering apparatus according to the embodiment of the disclosed disclosure; and

FIG. 11 is a view illustrating detailed processes in FIG. 10.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the embodiments, and the general contents in the technical field to which the disclosed disclosure pertains or the contents repeatedly described in the embodiments will be omitted. The terms ‘part,’ ‘module,’ ‘member,’ ‘block’ and the like as used in the specification may be implemented in software or hardware. Further, a plurality of ‘part,’ ‘module,’ ‘member,’ ‘block’ and the like may be embodied as one component. It is also possible that one ‘part,’ ‘module,’ ‘member,’ ‘block’ and the like includes a plurality of components.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

Throughout the specification, when one member is disposed “on” another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operation principles and embodiments of the disclosed disclosure will be described in detail with reference to the accompanying drawings.

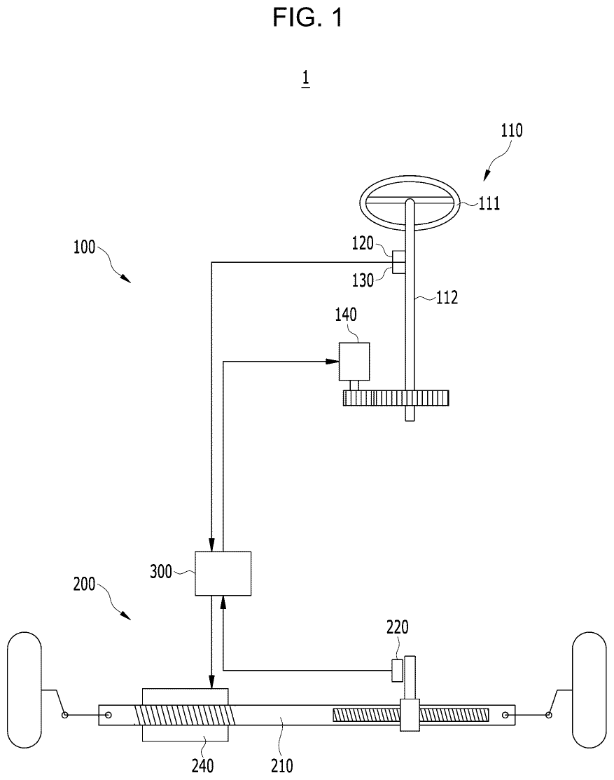

FIG. 1 is a view illustrating one example of a steering apparatus according to an embodiment of the disclosed disclosure.

With reference to FIG. 1, a steering apparatus 1 according to an embodiment of the disclosed disclosure may acquire a driver's steering intention applied through a steering wheel and change a traveling direction of a vehicle in accordance with the acquired steering intention. For example, the steering apparatus 1 may change a direction, in which rotation axes of wheels are directed, in accordance with the driver's steering intention.

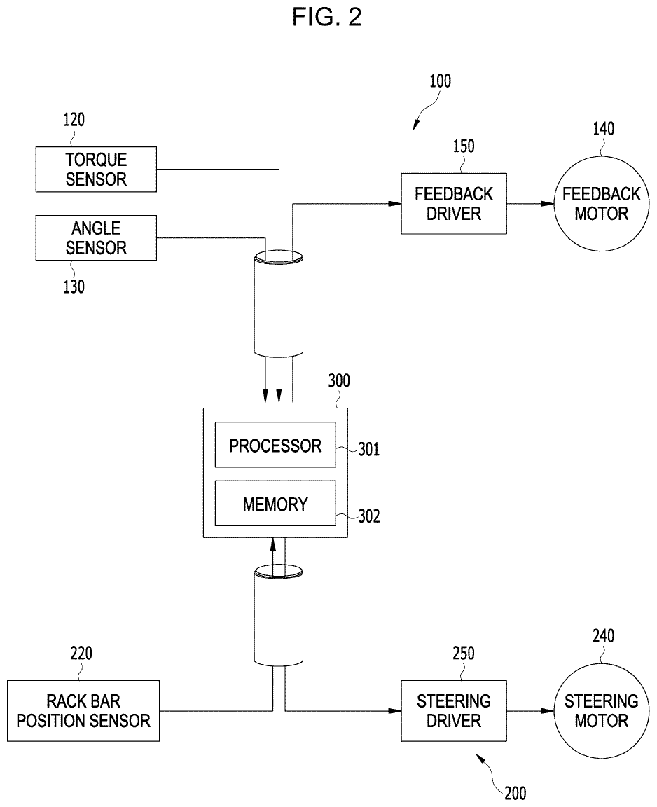

For example, as illustrated in FIGS. 1 and 2, the steering apparatus 1 may include a steering wheel actuator 100, a steering rack actuator 200, and a controller 300.

The steering wheel actuator 100 may be connected to the steering rack actuator 200 only electrically without being mechanically or fluidly connected.

The steering wheel actuator 100 may acquire the driver's steering intention applied through a steering wheel 111. In addition, the steering wheel actuator 100 may provide the steering wheel with feedback torque corresponding to a rack force applied to the wheels of the vehicle.

With reference to FIG. 2, the steering wheel actuator 100 may include a steering wheel assembly 110, a torque sensor 120, an angle sensor 130, a feedback motor 140, and a feedback driver 150.

The steering wheel assembly 110, the torque sensor 120, the angle sensor 130, the feedback motor 140, and the feedback driver 150 are not essential components of the steering wheel actuator 100, and at least some of the above-mentioned components may be excluded.

The steering wheel assembly 110 may include the steering wheel 111 configured to acquire, from the driver, an input related to the traveling direction of the vehicle or the driver's steering intention, and a steering column 112 configured to support the steering wheel 111. The steering wheel assembly 110 may be rotated clockwise or counterclockwise by the driver's steering intention.

The torque sensor 120 may detect the rotation of the steering wheel assembly 110 and measure torque applied to the steering wheel assembly 110 by the driver. The torque sensor 120 may provide the controller 300 with an electrical signal (hereinafter, referred to as a ‘torque signal’), as a detection signal, corresponding to the measured torque. For example, the torque sensor 120 may output a first detection signal, which includes a measurement value of the torque applied to the steering column 112, to the controller 300.

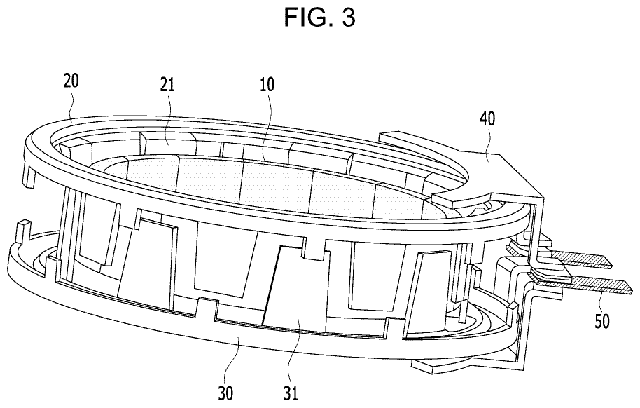

For example, with reference to FIG. 3, magnets 10 are coupled to an input shaft of the torque sensor 120, and the magnets 10 define a ring shape. Stators 20 and 30 may be disposed on an output shaft. The stators 20 and 30 may include vertical protruding pieces 21 and 31 disposed on outer peripheral surfaces of the magnets 10, spaced apart from one another, and bent in an axial direction. When torsion occurs on a torsion bar by a difference in rotation amount between the input shaft coupled to the magnets 10 and the output shaft coupled to the stators 20 and 30, the magnets 10 and the stators 20 and 30 rotate relatively. In this case, the outer peripheral surfaces of the magnets 10 and opposing surfaces between the vertical protruding pieces 21 and 31 are changed, and magnetization values are changed, such that the torque may be measured by utilizing the change in magnetization values. A collector is disposed to concentrate the magnetization value, and a magnetic element detects a magnetic value concentrated by the collector.

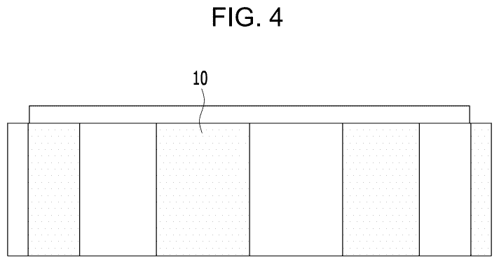

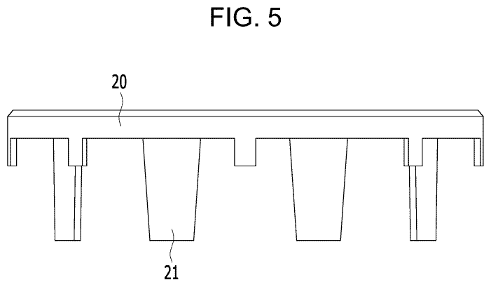

With reference to FIGS. 4 and 5, the magnets 10 are disposed constantly in a circumferential direction of the torque sensor 120, and the vertical protruding pieces 21 of the stators 20 are spaced apart from one another and disposed on the outer periphery so as to correspond to the arrangement of the magnets 10. Therefore, all the magnets 10 and the vertical protruding pieces 21 and 31 are constantly arranged in the circumferential direction. However, in this arrangement, because the torque sensor 120 has a limitation in ensuring an area capable of magnetizing the stators 20 and 30, the torque signal is weak and structurally vulnerable to an external magnetic field. For this reason, when the external magnetic field is detected, an error may easily occur on the torque signal.

The angle sensor 130 may detect a rotation of the steering wheel assembly 110 made by the driver and measure a rotation angle of the steering wheel assembly 110. The angle sensor 130 may provide the controller 300 with an electrical signal (hereinafter, referred to as an ‘angle signal’) corresponding to the measured rotation angle. For example, the angle sensor 130 may output a second detection signal, which includes a measurement value of the rotation angle of the steering column 112, to the controller 300.

The torque sensor 120 and the angle sensor 130 may constitute steering sensors 120 and 130. In other words, the steering sensors 120 and 130 may include at least one of the torque sensor 120, the angle sensor 130, and a rack bar position sensor 220.

The torque sensor 120 and the angle sensor 130 may detect the torque and rotation angle in a non-contact manner. For example, the torque sensor 120 and the angle sensor 130 may each include a Hall integrated circuit (IC). The torque sensor 120 and the angle sensor 130 may be attached to the steering column 112, convert a change in magnetic flux density of a magnet (not illustrated) configured to rotate in conjunction with the steering column 112 into an electrical signal, and transmit the electrical signal to the controller 300.

In addition, the torque sensor 120 and the angle sensor 130 may each include a contactless inductive position sensor application specific integrated circuit (CIPOS ASIC) and may convert physical position information, which is made by the rotations of the steering wheel 111 and/or the steering column 112, into an electrical signal and transmit the electrical signal to the controller 300.

If an external magnetic field is introduced into the torque sensor 120 and the angle sensor 130, an intensity of the magnetic field into the Hall IC rapidly changes in the torque sensor 120 and the angle sensor 130, such that the outputted first and second detection signal may be abnormally increased. For this reason, an erroneous operation of the steering apparatus 1, such as inadvertent steering and/or self steering, may occur.

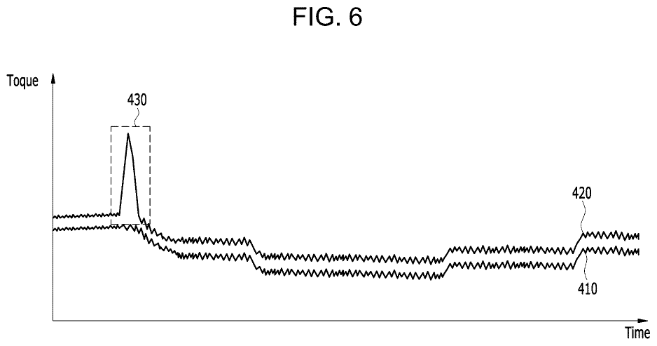

With reference to FIG. 6, the steering sensors 120 and 130 may identify a first line 410 indicating the amount 430 of change in detection signal of the steering sensor caused by the external magnetic field, and a second line 420 indicating a change amount of detection signal of the steering sensor in a normal state.

In FIG. 6, the detection signal of the steering sensor generated by the introduction of the external magnetic field indicates about two amounts of change in torque for a period of time of about 2 ms. In this case, the detection signal of the steering sensor generated by the introduction of the external magnetic field may suddenly react within a reference time of about 2 ms and be distinguished from a torque value generated by a steering driver.

With reference back to FIG. 1, the feedback motor 140 may be connected to the steering wheel assembly 110 through a speed reducer and provide the steering wheel assembly 110 with feedback torque. For example, the speed reducer may include a pulley-belt or a plurality of gears.

The feedback motor 140 may include a rotary shaft connected to the steering wheel assembly 110 through the speed reducer, a rotor connected to the rotary shaft, and a stator fixed to a housing. For example, the rotor may include permanent magnets having N-poles and S-poles alternately disposed along an outer surface thereof, and the stator may include a plurality of teeth disposed along the outer surface of the rotor, and a plurality of coils configured to surround the plurality of teeth, respectively.

The rotor may be rotated by a magnetic interaction with the stator, and the rotation of the rotor may be provided to the rotary shaft. The feedback motor 140 may receive a drive current controlled by the feedback driver 150. The plurality of coils included in the stator may form a magnetic field rotated at the periphery of the rotor by the drive current, and the rotor may be rotated by a magnetic interaction between the magnetic field of the rotor and the magnetic field of the stator.

The feedback driver 150 may control the drive current supplied to the feedback motor 140 in response to a feedback control signal of the controller 300. For example, the feedback driver 150 may include a three-phase inverter (or H-bridge) including a plurality of switching elements configured to control the drive current supplied to the feedback motor 140, and a gate driver configured to control the switching elements included in the three-phase inverter (or H-bridge) in response to the feedback control signal of the controller 300. The gate driver may provide the switching elements of the three-phase inverter (or H-bridge) with a driving signal for operating the three-phase inverter (or H-bridge) in response to the feedback control signal of the controller 300. The three-phase inverter (or H-bridge) may convert direct current power, which is supplied from a battery of the vehicle, into an alternating current power in response to the driving signal of the gate driver and provide the converted alternating current power to the feedback motor 140.

The steering rack actuator 200 may be connected to the steering wheel actuator 100 only electrically without being mechanically or fluidly connected.

The steering rack actuator 200 may move a rack bar to steer the vehicle in accordance with the driver's steering intention. In addition, the steering rack actuator 200 may identify a rack force applied to the rack bar.

With reference to FIG. 2, the steering rack actuator 200 may include a rack bar assembly 210, a steering motor 240, a steering driver 250, and the rack bar position sensor 220. The rack bar assembly 210, the steering motor 240, the steering driver 250, and the rack bar position sensor 220 are not essential components of the steering rack actuator 200, and at least some of the above-mentioned components may be excluded.

The rack bar assembly 210 may be connected to rotary shafts of the wheels and linearly moved by an operation of the steering motor 240. In order to change the traveling direction of the vehicle, the rack bar assembly 210 may change a direction in which the rotary shaft of the wheel is directed. For example, the rack bar assembly 210 may linearly move to rotate the rotary shaft of the wheel counterclockwise, such that the vehicle may be steered leftward. In addition, the rack bar assembly 210 may linearly move to rotate the rotary shaft of the wheel clockwise, such that the vehicle may be steered rightward.

The steering motor 240 may be connected to the rack bar assembly 210 by the speed reducer and provide torque for moving the rack bar assembly 210 linearly. For example, the speed reducer may include a pulley-belt or a plurality of gears.

The steering motor 240 may provide a rotational force for moving the rack bar assembly 210 leftward or rightward linearly in response to a steering control signal from the controller 300. For example, the rotation of the steering motor 240 may be converted into a linear motion by a rack gear, a pinion gear, and the like.

The steering motor 240 may include a rotary shaft connected to the rack bar assembly 210 through the speed reducer, a rotor connected to the rotary shaft, and a stator fixed to a housing. Because the steering motor 240 is similar in structure to the feedback motor 140, a specific description of the steering motor 240 will be replaced with the description of the feedback motor 140.

The steering driver 250 may control a drive current supplied to the steering motor 240 in response to the steering control signal of the controller 300. For example, the steering driver 250 may include a three-phase inverter (or H-bridge) including a plurality of switching elements configured to control the drive current supplied to the steering motor 240, and a gate driver configured to control the switching elements included in the three-phase inverter (or H-bridge) in response to the steering control signal of the controller 300. The gate driver may provide the switching elements of the three-phase inverter (or H-bridge) with a driving signal for operating the three-phase inverter (or H-bridge) in response to the steering control signal of the controller 300. The three-phase inverter (or H-bridge) may convert direct current power, which is supplied from a battery of the vehicle, into an alternating current power in response to the driving signal of the gate driver and provide the converted alternating current power to the steering motor 240.

The rack bar position sensor 220 may detect a linear movement of the rack bar assembly 210 and measure a displacement by which the rack bar assembly 210 moves. For example, the rectilinear motion of the rack bar assembly 210 may be converted into a rotational motion by a power conversion device, and the rack bar position sensor 220 may measure a displacement of the converted rotational motion. The rack bar position sensor 220 may provide the controller 300 with an electrical signal (position signal) corresponding to the measured displacement of the rack bar assembly 210.

The controller 300 may be coupled to the steering wheel actuator 100 or coupled to the steering rack actuator 200. In addition, the controller 300 may be physically separated from both the steering wheel actuator 100 and the steering rack actuator 200.

The controller 300 may be electrically connected to the steering wheel actuator 100 and the steering rack actuator 200.

The controller 300 may include a processor 301 configured to collect an operation of the steering apparatus 1, and a memory 302 configured to store or memorize programs and data for implementing a process of controlling an operation of the steering apparatus 1.

The processor 301 may provide a control signal for controlling the steering wheel actuator 100 in accordance with the driver's steering intention.

The processor 301 may process an angle signal of the angle sensor 130 and/or a torque signal of the torque sensor 120 and identify the driver's steering intention based on the processing of the angle signal and/or the torque signal. The processor 301 may identify a target position of the rack bar corresponding to the driver's steering intention and provide the steering driver 250 with the steering control signal corresponding to the target position. The steering driver 250 may control the drive current supplied to the steering motor 240 so that the rack bar assembly 210 follows the target position.

The processor 301 may process the position signal of the rack bar position sensor 220 and identify the rack force based on the processing of the position signal. The processor 301 may identify the feedback torque corresponding to the rack force and provide the feedback driver 150 with the feedback control signal corresponding to the feedback torque. The feedback driver 150 may control the drive current supplied to the feedback motor 140 to apply the feedback torque to the steering wheel assembly 110.

The processor 301 may provide the steering control signal to the steering driver 250 to move the rack bar assembly 210 to the target position. The steering driver 250 may control the drive current supplied to the steering motor 240 in response to the steering control signal. The steering motor 240 may provide the torque to move the rack bar assembly 210 to the target position.

The processor 301 may process the position signal of the rack bar position sensor 220. The processor 301 may identify a position, a speed, an acceleration, and/or the like of the rack bar assembly 210 based on the processing of the position signal.

The processor 301 may identify the rack force applied to the rack bar assembly 210 from the outside such as a tire of the wheel or the like based on the position, the speed, and/or the acceleration of the rack bar assembly 210. For example, the processor 301 may identify a restoring force of the rack bar assembly 210 and acquire the rack force by applying the restoring force of the rack bar assembly 210 to a motion equation.

The processor 301 may identify an estimated position based on an output of a motor position sensor configured to measure a rotational displacement of the steering motor 240, identify a measured position based on an output of the rack bar position sensor 220 configured to measure the position of the rack bar assembly, and identify the restoring force based on a product of a difference between the estimated position and the measured position and an elastic modulus of the speed reducer.

The processor 301 may identify an increase in frictional forces of the steering wheel assembly 110 and/or the rack bar assembly 210 and identify the cause thereof.

The processor 301 may provide the steering rack actuator 200 with a first test signal corresponding to a predetermined target position and identify an estimated rack force value based on an output signal from the rack bar position sensor 220. The processor 301 may compare the estimated rack force value with a rack force reference value stored in advance in the memory 302 and identify an increase in frictional force of the rack bar assembly 210 based on the estimated rack force value is larger than the rack force reference value.

The processor 301 may provide the steering wheel assembly 110 with a second test signal corresponding to predetermined feedback torque and identify an estimated feedback torque value based on an output signal from the angle sensor 130. The processor 301 may compare the estimated feedback torque value with a feedback torque reference value stored in advance in the memory 302 and identify an increase in frictional force of the steering wheel assembly 110 based on the estimated feedback torque value is larger than the feedback torque reference value.

When the processor 301 identifies the increase in frictional force of the rack bar assembly 210 and identifies the increase in frictional force of the steering wheel assembly 110, the steering apparatus 1 may identify an increase in frictional force caused by a low temperature.

When the increase in frictional force of the rack bar assembly 210 is identified and the increase in frictional force of the steering wheel assembly 110 is not identified, the processor 301 may identify an increase in frictional force of the rack bar assembly 210 caused by the introduction of foreign substances into the rack bar assembly 210.

When the processor 301 does not identify the increase in frictional force of the rack bar assembly 210 but identifies the increase in frictional force of the steering wheel assembly 110, the steering apparatus 1 may identify an increase in frictional force of the steering wheel assembly 110 caused by a mechanical defect of the steering wheel assembly 110.

If the increase in frictional force of the rack bar assembly 210 is not identified and the increase in frictional force of the steering wheel assembly 110 is not identified, the processor 301 may identify a normal operation of the steering apparatus 1.

The memory 302 may provide the stored programs and data to the processor 301 and memorize temporary data generated during the operation of the processor 301. For example, the memory 302 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The controller 300 may detect a fluctuation of a detection signal caused by an external magnetic field and identify erroneous operations of the steering sensors 120 and 130. In response to start-on (ON) of the vehicle and/or steering power-on (ON), the controller 300 may compare at least one change amount of the first detection signal and the second detection signal within the reference time with a reference change amount of at least one of the first detection signal and the second detection signal within the reference time. In this case, the first detection signal may include a measurement value of torque applied to the steering column 112. In addition, the second detection signal may include a measurement value of a rotation angle of the steering column 112. In addition, the reference time may be set to a predesignated unit time. For example, the reference time may be set to about 5 ms.

In addition, the reference amount of change may include a first reference change amount and a second reference change amount for the first detection signal and the second detection signal. The first reference change amount and the second reference change amount may each be set to a condition for determining straightness in a traveling route for the vehicle. For example, the first reference change amount may be set to the change amount of the first detection signal measured based on the angle signal and set to an angle of about 3 degrees or less. In addition, the second reference change amount may be set to the change amount of the second detection signal measured based on the torque signal and set to torque of about 0.3 Nm or less.

The controller 300 may primarily identify the occurrence of errors in the steering sensors 120 and 130 caused by the introduction of the external magnetic field based on the change amount of the first detection signal and the change amount of the second detection signal.

In addition, the controller 300 may compare a change rate of at least one of the first detection signal and the second detection signal within the reference time with a reference change rate of at least one of the first detection signal and the second detection signal within the reference time. For example, the reference change rate may include at least one of a first reference change rate and a second reference change rate for at least one of the first detection signal and the second detection signal. For example, the first reference change rate may be set to a torque change rate of about 0.1 Nm/ms or more in order to detect a torque change rate caused by the introduction of the external magnetic field.

The controller 300 may secondarily identify the occurrence of errors in the steering sensors 120 and 130 caused by the introduction of the external magnetic field based on the change rate of the first detection signal and the change rate of the second detection signal. In other words, the controller 300 may not only simply identify the occurrence of errors in the steering sensors 120 and 130 only based on the change amount of the first detection signal and the change amount of the second detection signal, but also identify the occurrence of errors in the steering sensors 120 and 130 by additionally comparing the change rate of the first detection signal and the change rate of the second detection signal.

When the occurrence of errors in the steering sensors 120 and 130 is identified, the controller 300 may correct the steering control signal based on the torque value of the steering motor 240 monitored at a predesignated reference time point. In addition, the controller 300 may output the corrected steering control signal to the steering driver 250. In this case, the controller 300 may output the steering control signal to the steering driver 250 for a predesignated reference output time. The reference output time may be set to a time (including a margin) for which the steering sensor returns to a normal state after the external magnetic field is removed.

In this case, when erroneous operations occur on the steering sensors 120 and 130 because of the introduction of the external magnetic field, the controller 300 may determine errors in the first and second detection signals of the steering sensors 120 and 130 and forcibly perform a predesignated operation of the steering motor 240 while ignoring the first detection signal and the second detection signal.

In this regard, when the occurrence of errors in the steering sensors 120 and 130 is identified, the controller 300 may correct the steering control signal based on the torque value of the steering motor 240 monitored at the reference time point. In addition, the controller 300 may output the corrected steering control signal to the steering driver 250. For example, the controller 300 may forcibly operate the steering motor 240 in accordance with an operational condition (normal condition) of the steering motor 240 that normally operates before the occurrence of errors in the steering sensors 120 and 130 is identified. The controller 300 may control the operation of the steering motor 240 based on the normal condition, thereby normally returning the rack bar assembly 210 that has been erroneously moved by the errors in the steering sensors 120 and 130.

When the occurrence of errors in the steering sensors 120 and 130 is identified, the controller 300 may output a warning notification by using an output device (not illustrated) provided in the vehicle. In addition, the controller 300 may output a warning notification to the outside of the vehicle (other devices or other vehicles) by using a separate communication device.

For example, the controller 300 may output a message for warning of the occurrence of errors by using a display of the vehicle. In addition, the controller 300 may output light in a lighting pattern for warning of the occurrence of errors by using a lamp of the vehicle. In addition, the controller 300 may output a sound for warning of the occurrence of error by using a speaker of the vehicle.

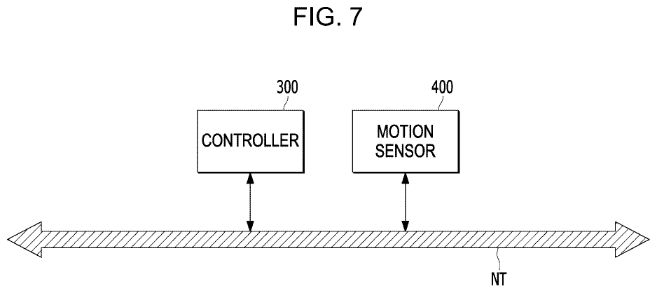

With reference to FIG. 7, the controller 300 may communicate with a motion sensor 400 provided in the vehicle by using a communication network NT. In addition, the controller 300 may identify a traveling direction of the vehicle based on a comparison between at least one of the first and second detection signals and an output signal from the motion sensor 400 provided in the vehicle. In this case, the controller 300 may identify a target yaw rate of the vehicle based on at least one of the first and second detection signals and identify a current yaw rate of the vehicle based on the output signal from the motion sensor 400. The controller 300 may determine the straightness of the vehicle in the traveling route for the vehicle based on a yaw rate error between the target yaw rate and the current yaw rate of the vehicle. For example, when the yaw rate error between the target yaw rate and the current yaw rate is low, it may be determined that the current vehicle travels straight.

When it is identified that the current vehicle travels straight, the controller 300 may perform steering corresponding to the driver's steering intention based on the first and second detection signals of the steering sensors 120 and 130.

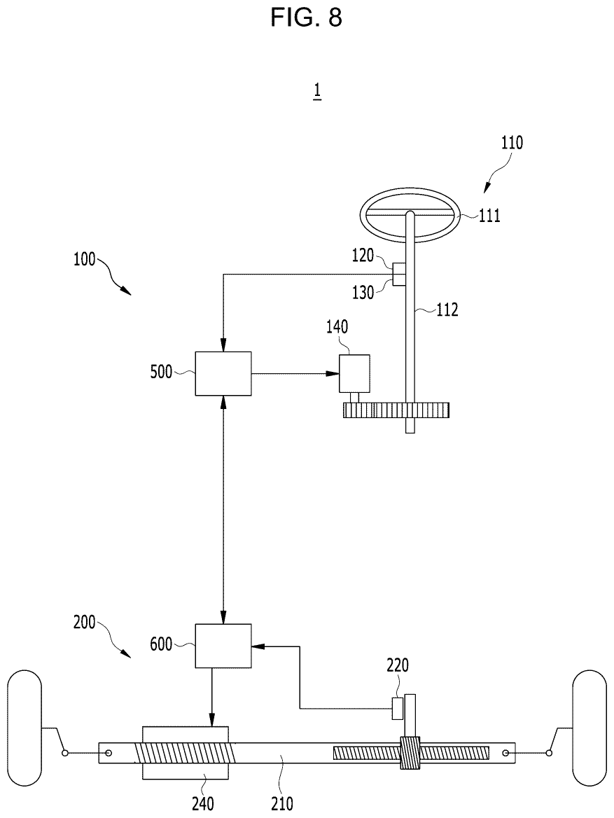

FIG. 8 is a view illustrating another example of the steering apparatus according to the embodiment of the disclosed disclosure.

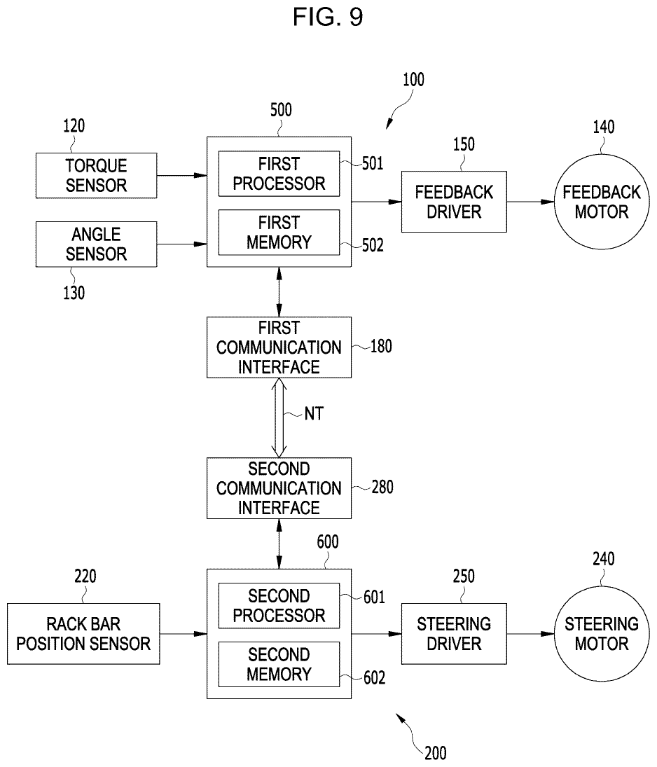

FIG. 9 is a view illustrating another example of a control configuration of the steering apparatus according to the embodiment of the disclosed disclosure.

In this case, the description will be focused on a difference from FIGS. 1 and 2 in order to avoid the repeated description.

With reference to FIGS. 8 and 9, a first controller 500 may include a first processor 501 configured to provide a control signal for controlling the steering wheel actuator 100 in accordance with the driver's steering intention, and a first memory 502 configured to store or memorize programs and data for implementing a process of controlling the steering wheel actuator 100.

The first memory 502 may provide the stored programs and data to the first processor 501 and memorize temporary data generated during the operation of the first processor 501. For example, the first memory 502 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The first processor 501 may be electrically connected to the torque sensor 120, the angle sensor 130, a first communication interface 180, the feedback driver 150, and/or the feedback motor 140.

The first processor 501 may process an angle signal of an angle sensor 120 and/or a torque signal of a torque sensor 130. The first processor 501 may identify the driver's steering intention based on the processing of the angle signal and/or the torque signal. In addition, the first processor 501 may identify a target position of the rack bar included in the steering rack actuator 200 corresponding to the driver's steering intention.

The first processor 501 may provide the first communication interface 180 with a communication signal corresponding to the target position in order to transmit the target position to the steering rack actuator 200 through the communication network NT.

In addition, the first processor 501 may acquire, from the first communication interface 180, a communication signal corresponding to the rack force received from the steering rack actuator 200 through the communication network NT. The first processor 501 may identify the rack force based on the processing of the received communication signal.

The first processor 501 may identify the feedback torque corresponding to the rack force and provide the feedback driver 150 with the feedback control signal so that the feedback motor 140 generates the feedback torque corresponding to the rack force. The feedback driver 150 may control the drive current supplied to the feedback motor 140 in response to the feedback control signal. The feedback motor 140 may provide the steering wheel assembly 110 with the feedback torque corresponding to the rack force.

The first communication interface 180 may send or receive communication signals to or from the steering rack actuator 200 through the communication network NT. For example, the first communication interface 180 may acquire a transmission signal from the first processor 501 and transmit the transmission signal to the steering rack actuator 200 through the communication network NT of the vehicle. In addition, the first communication interface 180 may acquire a reception signal from the steering rack actuator 200 through the communication network NT of the vehicle and provide the reception signal to the first processor 501.

For example, the first communication interface 180 may include a CAN transceiver configured to transmit or receive a signal by using a controller area network (CAN) protocol.

A second controller 600 may include a second processor 601 configured to provide a control signal for controlling the steering rack actuator 200 in accordance with the driver's steering intention, and a second memory 602 configured to store or memorize programs and data for implementing a process of controlling the steering rack actuator 200.

The second memory 602 may provide the stored programs and data to the second processor 601 and memorize temporary data generated during the operation of the second processor 601. For example, the second memory 602 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The second processor 601 may be electrically connected to a second communication interface 280, the steering driver 250, the steering motor 240, and/or the rack bar position sensor 220.

The second processor 601 may acquire, from the second communication interface 280, a communication signal corresponding to the target position received from the steering wheel actuator 100 through the communication network NT. The second processor 601 may identify the target position of the rack bar assembly 210 based on the processing of the communication signal.

The second processor 601 may provide the steering control signal to the steering driver 250 to move the rack bar assembly 210 to the target position. The steering driver 250 may control the drive current supplied to the steering motor 240 in response to the steering control signal. The steering motor 240 may provide the torque to move the rack bar assembly 210 to the target position.

The second processor 601 may process the position signal of the rack bar position sensor 220. The second processor 601 may identify a position, a speed, an acceleration, and/or the like of the rack bar assembly 210 based on the processing of the position signal.

The second processor 601 may identify the rack force applied to the rack bar assembly 210 from the outside such as a tire of the wheel or the like based on the position, the speed, and/or the acceleration of the rack bar assembly 210.

For example, the second processor 601 may identify a restoring force of the rack bar assembly 210 and acquire the rack force by applying the restoring force of the rack bar assembly 210 to a motion equation.

The second processor 601 may identify an estimated position based on an output of a motor position sensor configured to measure a rotational displacement of the steering motor 240, identify a measured position based on an output of the rack bar position sensor 220 configured to measure the position of the rack bar assembly, and identify the restoring force based on a product of a difference between the estimated position and the measured position and an elastic modulus of the speed reducer.

The second processor 601 may provide the second communication interface 280 with a communication signal corresponding to the rack force in order to transmit the rack force to the steering wheel actuator 100 through the communication network NT.

As described above, the steering wheel actuator 100 may acquire the driver's steering intention through the steering wheel assembly 110 and transmit the target position, which corresponds to the steering intention, to the steering rack actuator 200. The steering rack actuator 200 may move the rack bar assembly 210 to the target position and transmit the rack force, which is applied to the rack bar assembly 210 from the outside, to the steering wheel actuator 100. The steering wheel actuator 100 may provide the driver with the feedback torque corresponding to the rack force through the steering wheel assembly 110.

As described above, a rack force (Froad) may be acquired by a restoring force (Fb), a reduction ratio (R), a frictional force (Ffric), a mass (M), and an acceleration (a) of the rack bar assembly 210.

The second communication interface 280 may send or receive communication signals to or from the steering wheel actuator 100 through the communication network NT. For example, the second communication interface 280 may acquire a transmission signal from the second processor 601 and transmit the transmission signal to the steering wheel actuator 100 through the communication network NT of the vehicle. In addition, the second communication interface 280 may acquire a reception signal from the steering wheel actuator 100 through the communication network NT of the vehicle and provide the reception signal to the second processor 601.

For example, the second communication interface 280 may include a CAN transceiver configured to transmit or receive a signal by using a controller area network (CAN) protocol.

The steering apparatus according to the embodiment of the disclosed disclosure may identify the occurrence of an error in the steering sensor caused by the introduction of the external magnetic field. Therefore, it is possible to prevent an erroneous operation of the steering motor by transmitting the corrected control signal to the steering driver.

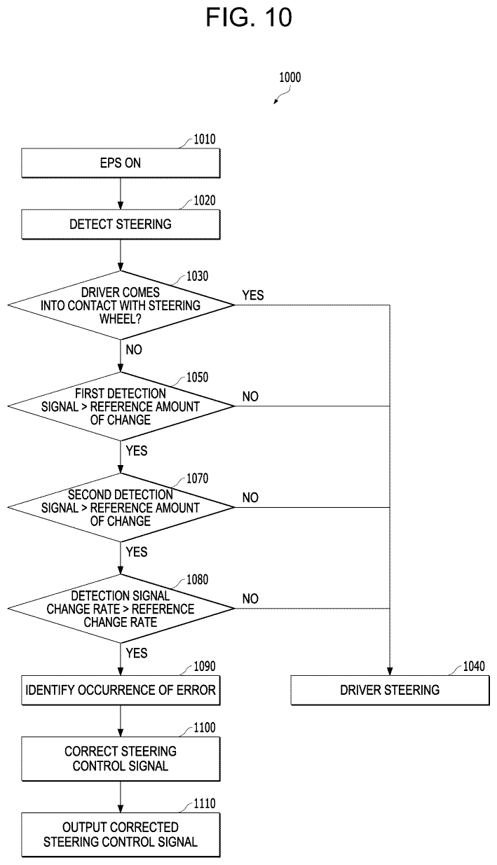

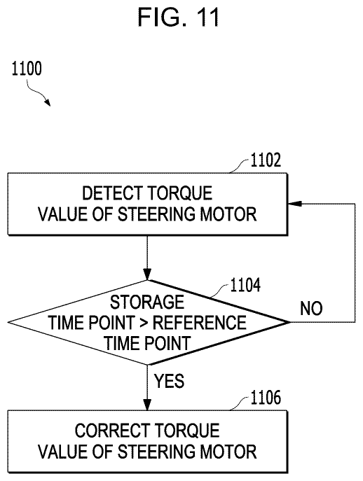

Hereinafter, a method of controlling the steering apparatus according to the embodiment of the disclosed disclosure will be described with reference to FIGS. 10 and 11. In this case, the control method will be described with reference to the steering apparatus according to the above-mentioned embodiment.

FIG. 10 is a view illustrating one example of the method of controlling the steering apparatus according to the embodiment of the disclosed disclosure.

FIG. 11 is a view illustrating detailed processes in FIG. 10.

In this case, a method 1000 of identifying, by the steering apparatus 1, the occurrence of errors in the steering sensors 120 and 130 will be described with reference to FIGS. 10 and 11.

The operations described below are not essential operations of the method 1000 of identifying, by the steering apparatus 1, the occurrence of errors in the steering sensors 120 and 130, and at least some of the operations may be excluded.

The steering sensors 120 and 130 of the steering apparatus 1 may detect steering of the vehicle (1020) in response to the start-on of the vehicle (1010). For example, the steering sensors 120 and 130 may detect the steering of the vehicle by outputting a detection signal corresponding to the rotational displacements of the steering wheel 111 and/or the steering column 112.

The steering apparatus 1 may identify whether the driver comes into contact with the steering wheel 111 based on the detection of the steering of the vehicle (1030). For example, the controller 300 may identify a rotation of the steering wheel 111 made by the driver based on output signals from the steering sensors 120 and 130. When the contact of the driver with the steering wheel 111 is identified, the steering apparatus 1 may perform the steering made by the driver (1040).

When the contact of the driver with the steering wheel 111 is not identified, the steering apparatus 1 may compare the change amount of the first detection signals of the steering sensors 120 and 130 with the reference amount of change (1050). For example, the controller 300 may compare the change amount of the first detection signal within the reference time with the reference amount of change within the reference time. When the change amount of the first detection signal does not exceed the reference amount of change, the steering apparatus 1 may perform the steering made by the driver (1040).

When the change amount of the first detection signal exceeds the reference amount of change, the steering apparatus 1 may compare the change amount of the second detection signals of the steering sensors 120 and 130 with the reference amount of change (1070). For example, the controller 300 may compare the change amount of the second detection signal within the reference time with the reference amount of change within the reference time. The controller 300 may primarily identify the occurrence of errors in the steering sensors 120 and 130 caused by the introduction of the external magnetic field by comparing the change amount of the first and second detection signals with the reference amount of change. When the change amount of the second detection signal does not exceed the reference amount of change, the steering apparatus 1 may perform the steering made by the driver (1040).

When the change amount of the second detection signal exceeds the reference amount of change, the steering apparatus 1 may compare the change rates of the first and second detection signals of the steering sensors 120 and 130 with the reference change rate (1080). For example, the controller 300 may compare the change rates of the first and second detection signals within the reference time with the reference change rate within the reference time. When the change rates of the first and second detection signals do not exceed the reference change rate, the steering apparatus 1 may perform the steering made by the driver (1040).

The controller 300 may secondarily identify the occurrence of errors in the steering sensors 120 and 130 caused by the introduction of the external magnetic field by comparing the change rates of the first and second detection signals with the reference change rate.

When the change rates of the first and second detection signals exceed the reference change rate, the steering apparatus 1 may finally identify the occurrence of errors in the steering sensors 120 and 130 caused by the introduction of the external magnetic field (1090).

When the occurrence of errors in the steering sensors 120 and 130 is identified, the steering apparatus 1 may correct the steering control signal based on the torque value of the steering motor monitored at the predesignated reference time point.

The controller 300 may detect the torque value of the steering motor stored in the memory 302 (1102), identify effectiveness of the torque value by comparing a time point of storage of the detected torque value with the reference time point (1104), and correct the steering control signal with the torque value of the steering motor with the identified effectiveness (1106).

The steering apparatus 1 may output the corrected steering control signal to the steering driver 250 (1110). The steering driver 250 may control the drive current of the steering motor 240 based on the corrected steering control signal.

The method of controlling the steering apparatus according to the embodiment of the disclosed disclosure may additionally compare and verify the change rate of the detection signal as well as the change amount of the detection signal, thereby effectively verifying an error in the steering sensor caused by the introduction of the external magnetic field and improving the verification reliability.

Therefore, the method of controlling the steering apparatus according to the embodiment of the disclosed disclosure may stably stop the vehicle by preventing the vehicle from tilting in the braking situation when any one of the electromechanical brakes respectively provided in the plurality of wheels of the vehicle malfunctions. Therefore, it is possible to stably stop the vehicle by preventing the vehicle from tilting even in the situation in which the braking force of the wheel with a failure is maintained at a predetermined value.

On the other hand, the disclosed embodiments may be implemented in the form of a recording medium that stores computer-executable instructions. The instruction may be stored in the form of a program code. When the instruction is executed by a processor, a program module may be generated, and operations of the disclosed embodiments may be performed. The recording medium may be implemented as a computer-readable recording medium.

Examples of the computer-readable recording medium include all kinds of recording media for storing instructions readable by a computer. Specific examples thereof may include a read only memory (ROM), a random access memory (RAM), a magnetic tape, a magnetic disc, a flash memory, an optical data storage device, and the like.

The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. For example, a “non-transitory storage medium” may include a buffer that temporarily stores data.

As described above, the embodiments have been described with reference to the accompanying drawings. A person skilled in the art may understand that the present disclosure may be carried out in other forms different from those disclosed in the embodiments without changing the technical spirit or the essential features of the present disclosure. The disclosed embodiments are illustrative and should not be interpreted as being restrictive.

What is claimed is:

1. A steering apparatus comprising:
a steering wheel provided in a vehicle;
a steering sensor configured to output first and second detection signals corresponding to a rotational displacement of the steering wheel; and
a controller configured to identify the occurrence of an error in the steering sensor caused by an external magnetic field based on the first and second detection signals,
wherein the controller is configured to identify the occurrence of the error in the steering sensor by comparing a change amount of at least one of the first and second detection signals within a reference time with a reference change amount of at least one of the first and second detection signals within the reference time in response to start-on of the vehicle and comparing a change rate of at least one of the first and second detection signals within the reference time with a reference change rate of at least one of the first and second detection signals within the reference time.

2. The steering apparatus of claim 1, wherein the steering apparatus further comprises:
a steering column configured to support the steering wheel and rotate while corresponding to a rotation of the steering wheel;
a rack bar assembly connected to a rotary shaft of a wheel provided in the vehicle;
a steering motor connected to the rack bar assembly and configured to provide torque related to a movement of the rack bar assembly based on a steering control signal of the controller; and
a steering driver configured to control a drive current supplied to the steering motor based on the steering control signal, and
wherein the controller is configured to correct the steering control signal based on a torque value of the steering motor monitored at a predesignated reference time point and output the corrected steering control signal to the steering driver when the occurrence of the error in the steering sensor is identified.

3. The steering apparatus of claim 2, wherein the controller is configured to detect the monitored torque value of the steering motor, identify effectiveness of the detected torque value by comparing a time point of storage of the detected torque value with a reference time point, and correct the steering control signal based on the torque value with the identified effectiveness.

4. The steering apparatus of claim 3, wherein the reference time point is set to be before a time when the occurrence of the error in the steering sensor identified.

5. The steering apparatus of claim 2, wherein the controller is configured to output the steering control signal to the steering driver for a predesignated reference output time.

6. The steering apparatus of claim 5, wherein the reference output time is set to a time for which the steering sensor returns to a normal state after the external magnetic field is removed.

7. The steering apparatus of claim 2, wherein the steering sensor comprises:
a first sensor configured to detect a rotation of the steering column and measure torque applied to the steering column by a driver; and
a second sensor configured to detect a rotation of the steering wheel made by the driver and measure a rotation angle of the steering column.

8. The steering apparatus of claim 7, wherein the first detection signal includes a measurement value of the torque applied to the steering column, and the second detection signal includes a measurement value of the rotation angle of the steering column.

9. The steering apparatus of claim 8, wherein the controller is configured to output the steering control signal to the steering driver to linearly move the rack bar assembly based on at least one of the first and second detection signals.

10. The steering apparatus of claim 1, wherein the controller is configured to output a warning notification by using an output device provided in the vehicle when the occurrence of the error in the steering sensor is identified.

11. A method of controlling a steering apparatus, which comprises a steering wheel provided in a vehicle, a steering sensor configured to output first and second detection signals corresponding to a rotation of the steering wheel, and a controller configured to identify the occurrence of an error in the steering sensor caused by an external magnetic field based on the first and second detection signals, the method comprising:
identifying the occurrence of the error in the steering sensor by comparing a change amount of at least one of the first and second detection signals within a reference time with a reference change amount of at least one of the first and second detection signals within the reference time in response to start-on of the vehicle and comparing a change rate of at least one of the first and second detection signals within the reference time with a reference change rate of at least one of the first and second detection signals.

12. The method of claim 11, further comprising:
correcting, by the controller, a steering control signal based on a torque value of a steering motor monitored at a predesignated reference time point and outputting the corrected steering control signal to a steering driver when the occurrence of the error in the steering sensor is identified.

13. The method of claim 12, further comprising:
detecting, by the controller, the monitored torque value of the steering motor, identifying effectiveness of the detected torque value by comparing a time point of storage of the detected torque value with a reference time point, and correcting the steering control signal based on the torque value with the identified effectiveness.

14. The method of claim 13, further comprising:
setting, by the controller, the reference time point to a time point before the occurrence of the error in the steering sensor is identified.

15. The method of claim 12, further comprising:
outputting, by the controller, the steering control signal to the steering motor for a predesignated reference output time.

16. The method of claim 15, further comprising:
setting, by the controller, the reference output time to a time for which the steering sensor returns to a normal state after the external magnetic field is removed.

17. The method of claim 12, wherein the steering sensor comprises:
a first sensor configured to detect a rotation of a steering column and measure torque applied to the steering column by a driver; and
a second sensor configured to detect a rotation of the steering wheel made by the driver and measure a rotation angle of the steering column.

18. The method of claim 17, wherein the first detection signal includes a measurement value of the torque applied to the steering column, and the second detection signal includes a measurement value of the rotation angle of the steering column.

19. The method of claim 11, further comprising:
outputting, by the controller, the steering control signal to the steering driver to linearly move the rack bar assembly based on at least one of the first and second detection signals.

20. The method of claim 11, further comprising:
outputting, by the controller, a warning notification by using an output device provided in the vehicle when the occurrence of the error in the steering sensor is identified.
